(19) United States
(12) Patent Application Publication
(10) Pub. No.: US 2020/0193854 A1
(43) Pub. Date: Jun. 18, 2020

(54) VIRTUAL REALITY TRAINING METHOD FOR DEVELOPING SOFT SKILLS

(71) Applicant: Cantab Tecnología S. de R.L. de C.V., Mexico City (MX)

(72) Inventors: Pedro Eduardo Salinas Vela, Mexico City (MX); Bruno Ángel Caballero García León, Mexico City (MX); Ximena Durán Baca, Mexico City (MX); Ismael Tlapaya Tepech, Mexico City (MX); Fernando Sealtiel Marín Parra, Mexico City (MX)

(73) Assignee: Cantab Tecnología S. de R.L. de C.V., Mexico City (MX)

(21) Appl. No.: 16/223,822

(22) Filed: Dec. 18, 2018

(51) Int. Cl. G09B 5/12; G09B 19/00; G06F 3/01; G06T 19/00

(52) U.S. Cl. CPC G09B 5/125; G06T 19/003; G06F 3/011; G09B 19/00

(57) ABSTRACT

The present invention refers to the method of application of virtual reality for the development of soft skills, the user can choose different types of environments or scenarios. The main objective is to develop and promote skills such as empathy, self-knowledge, critical thinking among others. In order to promote and develop these skills, different Virtual Reality environments or scenarios are used, such as classrooms, schools with interacting students, departments and rooms in which social situation or problems like violence are represent in different environments such as: home, offices, houses, parks and streets. There may be various social context of the situations such as family, personal, harassment, violence of various types, etc. The Training consists in a tutorial and different number of sessions depending on the objective skill to develop.

### FIELD OF THE INVENTION

The present invention describes a method of training with Virtual Reality to develop “soft skills” in different types of environments or scenarios. The invention can be used in psychotherapy, education, self-help, home, training and entertainment environments and produced with computer hardware and computer software.

### BACKGROUND OF THE INVENTION

The use of virtual reality has been proven effective in the treatment to different problems, from distraction of pain in various diseases, and important positive effects in hospitalized patients (Chirico, Lucidi, De Laurentiis, Milanese, Napoli & Giordano 2015). Not all programs are successful in developing skills. One possible explanation is that despite the fact that participants are taught to develop skills, there is little opportunity to practice these skills or receive feedback, so it can be difficult to acquire these skills, especially if they are new or complex (Rowe Jouriles and McDonald, 2015).

One of the advantages of VR is that helps participants to have a sense of presence, which can be defined as the subjective experience of being in an environment even if one is not physically present (Robillard, Bouchard, Fournier and Renaud, 2003). In other words, participants can experience the virtual environment as real. VR has been used successfully in the treatment of a variety of disorders and has been used to create successful clinical applications for anxiety disorders, such as fear of flying or fear of heights and in the specific case of violence to teach self-help skills. resistance in the case of rape and to reduce victimization in adolescent women (Jouriles, McDonald, Kuliowatz, Rosenfield, Goniez and Cuevas. 2009; Rowe, Jouriles & McDonald, 2015). Through these programs it has been shown that VR constitutes a promising field for teaching and acquiring skills, especially those skills that are difficult to put into practice in real scenarios, especially in vulnerable conditions.

There are various technologies by which Virtual Reality, devices work. These systems are characterized by the user's immersion in the virtual plane generated by the technology and don be used in a wide variety of applications and training. Among the main applications that have been developed today for virtual reality devices are focused on recreational activities such as games and videos. There are also applications in various industries such as medicine and engineering for training and coaching. One of the newest applications in the field of virtual reality, is the use of these devices as therapy or training to deal with various situations of stress, phobia, abuse or bullying Implementing a teaching methodology with virtual reality allows users to use and put into practice soft skills that are difficult to acquire or practice in real scenarios.

The prior art search identified the U.S. Pat. No. 6,425,764B1 (2002)—“Virtual reality immersion therapy for treating psychological, psychiatric, medical, educational and self-help problems”, which describes a method for treating psychological, psychiatric or medical conditions using virtual reality environments. However, it is not focused in the development of soft skills. Rather, it is focused as a method of treating a psychological, psychiatric, or medical condition. Before using this virtual reality technology, a patient must first visit a physician or health care professional to evaluate his or her condition, diagnose, and choose the proper treatment.

Another patent identified as US20150004591A1—“Device, system, method, and computer-readable medium for providing an educational, text-based interactive game”. It protects a method, device, system, and computer medium for implementing and/or providing an educational, text-based, interactive game. It can be used on mobile communication devices such as cellphones, tablet computer, personal digital assistants, or any device that supports short or multimedia message services. The invention refers to an interactive game that uses scheduled messages to enhance the interactive user experience and can be used for various social causes, issues and goods including teen pregnancy and bullying. However, it does not have a virtual reality element.

Other patent identified as US20180174339A1—“Augmented reality apparatus and method”. In this case, it describes a method for teaching, coaching or demonstrating task or action to student, involving displaying image, synchronizing image of student with image of demonstration, and performing comparative analysis of images. However, even when it is a teaching method using virtual aid, it is focused for training and physical tasks, not for the development of socioemotional skills.

### SUMMARY OF THE INVENTION

The present invention refers to the method of application of virtual reality for the development of soft skills (FIG. 1). The main objective is the development and enhancement of soft skills including but not limited to empathy, auto-knowledge and critical thinking. To achieve these skills, it's necessary to use scenarios by means of virtual reality technology. The method starts with the creation of the environment or situation that will be used as context for the development of the skills (FIG. 6). The virtual reality program (6) recreates different spaces such as classrooms, open spaces (including but not limited to parks), offices or rooms where practical strategies are implemented, putting users in real-life social scenarios that often occur in this type of environments. Different roles are considered in these situations: aggressor, victims and bystanders. The user is exposed to different situations (9) for numerous sessions. During these sessions, the user must face different social situations through a videogame-like interface, where he or she is asked behavioral questions. Different choices are displayed depending of the skill that is to be improved. The user must choose the option that he or she relates most using the videogame control (4). The user then receives automatic feedback (12) directly related to the chosen course of action. The software (6) can either be managed by a responsible person (e.g. psychologist or school counselor) who can follow up the sessions of the users, or autonomously (5).

### BRIEF DESCRIPTION OF THE DRAWINGS

FIG. 1. Is a block diagram of the method of training with Virtual Reality to develop “soft skills” in different types of environments or scenarios.

FIG. 2. is a flowchart illustrating the implementation method of the virtual environment training system.

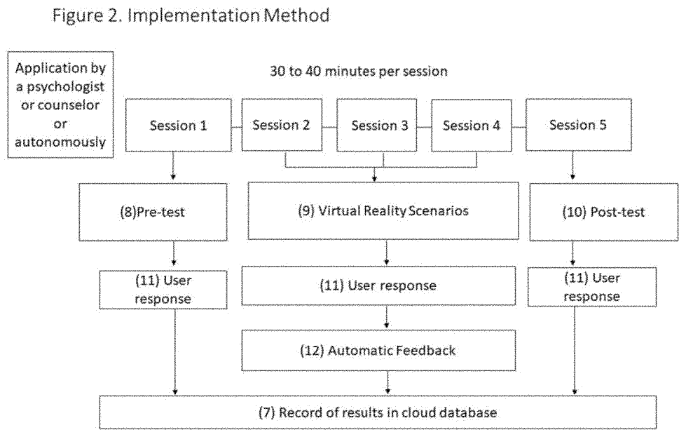

FIG. 3. is a diagram detailing the activities carried out each session of this training method.

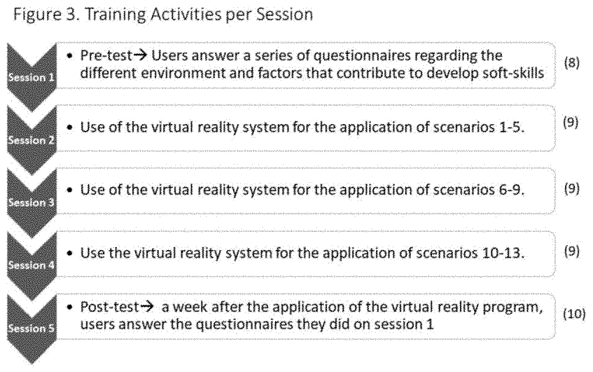

FIG. 4. Is a block diagram presenting an example of the types of scenarios shown to participants in each level of the training method.

FIG. 5. Is a block diagram showing how a virtual environment is used to develop the participants' soft skills, as well as how participants' answers are registered within the cloud database.

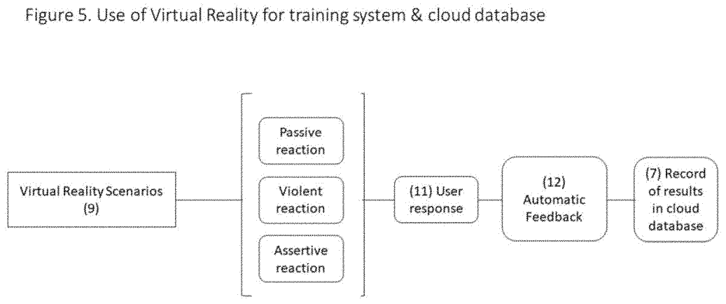

FIG. 6. Is a block diagram showing how the psychosocial scenarios are made in order to develop soft skills according to real life situations.

### DETAILED DESCRIPTION OF THE INVENTION

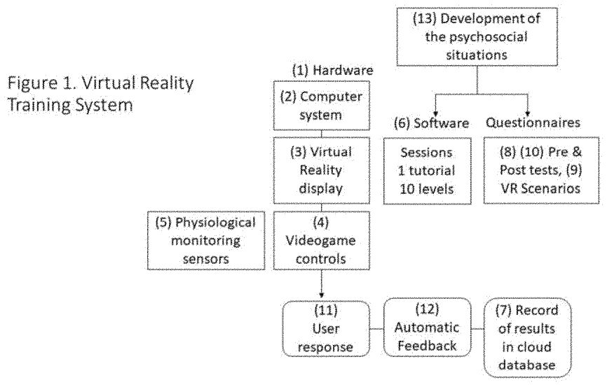

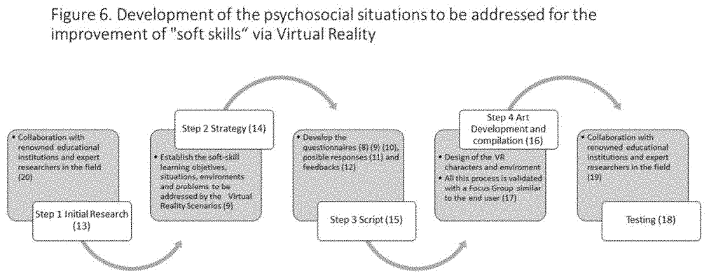

The present invention refers to the method of application of virtual reality (6) for the development of soft skills (FIG. 1). The method starts with the creation of the virtual reality environment or situation that will be used as context for the development of the skill (FIG. 6). The training method comprises several steps, described below:

Step 1 initial research (13)

The initial research is carried out in collaboration with renowned educational institutions and expert researchers in the field (19); Through this research, it is determined which are the most common and important psychosocial situations to be addressed for the improvement of certain “soft skills”. This research is carried out from databases of national and international indexed journals, thus ensuring that the information that is collected is based on the scientific literature.

Step 2 Strategy (14)

Once the necessary context to understand the problem and the situations to be addressed has been collected, as well as to know the scenarios in which they are triggered. The earning objectives for each of the capsules of the experience with virtual reality (9). Here are also defined how many situations will be necessary and the way the problems will be addressed. The objectives, as well as the information collected is validated by the experts to write the scripts (15).

Step Script (15).

When the objectives have been defined and validated then the writing of the Script (15) begins, the selected problems are addressed in accordance with the established objectives. Each script has an associated learning objective. Which will be evaluated within the same training (12).

The script (15) also has a format to be followed, which the user is presented with a problem with different solutions, however, only one of these solutions is correct, the incorrect solutions will lead to experience the consequences of their decision (12). The correct solution leads the user to experience the positive consequence, receiving feedback (12), and allowing to continue advancing in the experience.

In this step, in addition to describing the scripts, the description of the scenarios and the design of the 3D animations are also made (16),

Step 4 Art Development and Integration (16)

In this Step of the method, once the descriptions of the scenarios have been validated by the experts (19), develop begins. While the design area works on the details, begins the animation of these. All this process is validated with a Focus Group created according to the characteristics of the target users, to achieve a better compel of the users (17), the visual elements, the language and the content.

Step 5 Testing (18)

For the program testing (18), first a series of research is carried out on the existing evaluation instruments aligned with the objectives of the experiences developed. In order to assure the best assessment tool, the testing phase are made with the support of universities or expert researchers (19).

The software of virtual reality (6) has been designed with game mechanics to facilitate the teaching process of the user, including hardware (1) such as: camera control and selection of answers, which provides a more meaningful learning. The continuous process of participation and feedback allows the progress in the development of the sessions.

For the program (6) be evaluated, validated and standardized, different instruments are selected aligned to the objectives of the experiences.

An evaluation is carried out before the training or the users have contact with the developed experiences (8), and a final evaluation is then carried out, once the users have had contact with experiences (10).

All these instruments are preloaded in a digital tablet, which facilitates interaction, as well as obtaining data, since they are uploaded to the cloud to be analyzed, the results are compared to know if a change existed from the experience with the VR situations. In addition, the data of all the user's responses is stored, which allows to generate a profile of the users and key performance indicators (7).

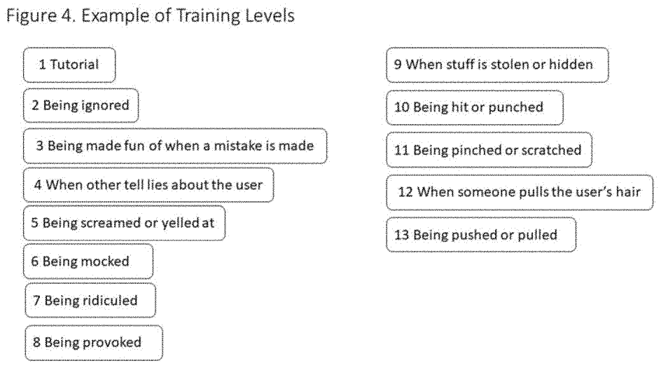

The virtual reality program (6) recreates different spaces such as classrooms, open spaces, offices or rooms where practical strategies are implemented, putting users in real-life social scenarios that often occur in this type of environments (FIG. 4). Different roles are considered in these situations: aggressor, victims and bystanders.

The method includes a virtual reality environment with voices, music, sounds, dialogues and other forms of psycho-pedagogical stimulation. The virtual reality system requires: a specialized computer system (2), a virtual reality display (3) (head-mounted display) or other form of visual stimulation such as screens and sound system that allow the user to have a virtual reality experience, and video game controls (4). It is also possible to use physiological monitoring sensors (5), allowing the system or applicator to have a more accurate assessment as to the user's reaction. Each participant is assigned an ID number with which he or she must log in. The identification number helps keep track of their progress and maintain privacy. These files are stored in a cloud database (7), making it possible to keep track of the participants' progress, review participants' answers in each level and identify the opportunity areas for soft-skills development. Additionally, business intelligence and relevant statistics are generated and shared with psychologist, institutions, tutors or organizations.

The assessment method to evaluate the skills (8) before and after the exposure of the user to the virtual reality, with the purpose of evaluating specific skills and the effectiveness of the program. The user is exposed to different situations for 5 sessions of approximately 30 to 40 minutes: the first and last involve questionnaires (8) to assess specific skills before and after the participant uses the virtual reality software (6); sessions 2, 3, and 4, require the virtual reality system. During these sessions, the user is exposed to different social situations through a videogame-like interface, where he or she is asked behavioral questions. Depending of the skill that the scenario intends to improve, different choices are displayed, for example; a passive reaction, a violent reaction and an assertive reaction (the latter being the recommended choice). The user must choose the option that he or she relates most using the videogame control (4). The user then receives automatic feedback directly related to the chosen course of action. The program includes a tutorial and different levels, each one involving different challenges based on real-life situations that will help participants acquire specific abilities to deal with different social psychological situations. The software (6) can either be managed by a responsible person (e.g. psychologist or school counselor) who can follow up the sessions of the users, or autonomously.

The main advantage of using the virtual reality training (FIG. 1) method compared traditional soft skills development methods is that, after completing the program, the user has developed behavioral skills to act accordingly to different situations. This results in a favorable impact on the interactions, assertively, response and self-awareness on different situations.

Training systems require the following hardware (1) resources for their operation.

In first place, it is necessary to have a specialized computer equipment (2), which covers the minimum requirements (described in the hardware section below) necessary to support and run the system.

Secondly, a virtual reality viewer (3) allow the user to immerse in the environment will be, presented.

In most cases, virtual reality lenses already have an integrated or external audio system and controls.

The environments have movement and camera control, allowing the selection of responses and interactions with the environment (5).

The minimum system requirements are:

A computer (2) with Intel Core i5 or higher, 2.5 Ghz, 4 GB RAM, 10 GB storage. Windows 8.1 or higher, a wireless network card and a stable and dedicated connection of at least 1 Mbps.

Regarding Virtual Reality Lenses (3), recommended:

Team Samsung Gear VR+Samsung Galaxy S8

Lenses (3):
Accelerometer
Dimensions: 98.8×207.8
Weight: 345
Integrated control
MicroUSB connection

Samsung galaxy:
Screen 5.8″, 1440×2960 pixels.
Snapdragon 835/Exynos 8895 processor.
4 GB RAM.
64 GB, microSD.
Camera: 12 MP.
Battery: 3000 mAh.
OS: Android 7.0.
Profile: 8 mm.

Oculus Go (3) that has the following characteristics:
CPU/RAM: Snapdragon 821+3 GB RAM
Storage: 32 GB or 64 GB
Weight: 468 grams.
LCD screen
Resolution: 2×1230 (2560)×1440 pixels
Connectivity: micro-USB/Bluetooth/Wi-Fi
Audio: Two integrated speakers and 3.6 mm jack so you can connect your headphones. The sound is 30 stereo
Tracking: It is a 3DOF device, which means that when you turn your head, they detect it. But they do not detect the movement if you start walking around the room
Controller (4): Wireless control command, more limited than the Oculus Touch. A single command
Average battery life. 2.5 hours

Oculus Rift (3) with the following characteristics:
OLED screen 2160×1200 px.
90 fps refresh rate.
Angle of vision: 110°.
Monitoring area: 1.5×3.3 m,
Operating sensors: Accelerometer, gyroscope, magnetometer and 365 degree positional system,
Weight: 470 g

PATENT CITATIONS

| Publication Number | Priority Date | Publication Date | Assignee | Title |
|---|---|---|---|---|
| US20150004591A1 | 2013 Jun. 27 | 2015 Jan. 1 | DoSomethingOrg | Device, system, method, |
| | | | | and computer-readable |
| | | | | medium for providing an |
| | | | | educational, text-based |
| | | | | interactive game. |
| U.S. Pat. No. 6,425,764B1 | 1997 Jun. 9 | 2002 Jul. 30 | Ralph J. Lamson | Virtual reality immersion |
| | | | | therapy for treating |
| | | | | psychological, psychiatric, |
| | | | | medical, educational and |
| | | | | self-help problems |
| US20180174339A1 | 2017 Apr. 19 | 2014 Mar. 20 | 2MEE Ltd | Augmented reality |
| | | | | apparatus and method |

What is claimed is:

1. A training method of applying virtual reality for the development of soft skills, it can be used in several social and psychological environments or situations, and for the development of different soft skills.

2. The use of the method in claim 1, including a software solution that is available through a video game-like interactive program; the method particularly seeks to:
a. Develop different psychosocial scenarios in order to develop different skills,
b. learn about the different environments and evaluating psychosocial situations (both the frequency and the intention of the same);
c. sensitize participants regarding the psychosocial situation;
promote and develop participants' skills in resolving different situations assertively;
e. identify the factors related to social and psychological problems and its impact on the participants; and
f. determine the satisfaction of the participants when participating in this type of programs.

3. The virtual reality, video game-like interactive program that is part of the method described in claim 1, consists of one tutorial and 12 levels, each one involving different challenges based on real-life situations that will help participants acquire specific abilities to deal with social or psychological situations.

4. The method as described in claim 1, wherein said method lowers the incidence of social and psychosocial problems and situation in different environments, by different spaces such as classrooms, homes, streets, offices, industries, disaster zones, common places or playgrounds, where strategies are implemented for all users in real situations. It consists of: One to Ten sessions lasting from 5 to 120 minutes, Assessments (questionnaires) before and after the exposure of the user to the virtual reality program. Scenarios based on real-life situations that consider one to five roles involved in social situations. Behavioral questions regarding said scenarios, where the user must choose the option that he or she relates to most. The automatic provision of feedback directly related to the chosen course of action.

5. The virtual reality technology used for the implementation of the training method of claim 1, including forms of psycho-pedagogical stimulation, including but not limited to voices, music, sounds and dialogues.

6. The software used according to claim 1, in the present assigns an ID number an He to each participant, saving them in a crud database. Thus, it is possible to:
a. Assign and save a file per participant in the cloud database,
b. Keep track of each students' progress while maintaining privacy,
c. Review students' answers in each level and identify who is susceptible to bullying,
d. Generate relevant statistics and business intelligence.

7. The questionnaires, scenarios, situations and solutions provided for the development of soft skills by the method described in claim 1 are made and validated by the collaboration of renowned organizations and expert psychologist, sociologist, anthropologist and academics. The method can be implemented by a responsible person who can follow up the sessions of the users. The software used in the method can run autonomously.

8. The virtual reality method according to claim 1, requires the following elements: a specialized computer system, specifically, computer equipment with: Processor: 3rd Generation Intel Core i5 2.5 Ghz, RAM: 4 Gb, Storage Space: 10 Gb, Windows 8.1 or higher, Connectivity: Wireless network card, Stable connection of at least 1 Mbps, Mouse, Headphones, Users may also require: Mousepad, Current extension cables, Multi-plug socket, a virtual reality viewer (head-mounted display) or another form of visual stimulation such as screens and sound system that allow the user to have a virtual reality experience, Video game controls. It is possible to use physiological monitoring sensors such as heart rate, pressure and the galvanic response of the skin (sweating).

9. The social and physiological situations that are developed and attended by the method described in claim 1 could be:
a. Violence,
b. Domestic Violence,
c. Harassment,
d. Child abuse,
e. Bullying,
f. Racism,
g. Homophobia,
h. Social and Economical Inequality,
i. Anti-social behaviors,
j. Teen pregnancy,
k. Animal abuse,
l. Xenophobia,
m. Drug abuse,
n. Depression,
o. Difficulty to interact,
p. Linguistic problems,
q. Martial problems,
r. Lack of self-security.

10. The soft skills that are improved by the method described in claim 1 could be:
a. Self-confidence,
b. Managing,
c. Time management,
d. Leadership,
e. Ethics,
f. Problem solving skills,
g. Listening,
h. Fast reaction,
i. Team building,
j. Communication,
k. Agility,
l. Negotiation,
m. Selling,
n. Effectiveness,
o. Stress management,
p. Performance,
q. Assertiveness,
r. Creativity,
s. Empathy,
t. Observation,
u. Critical Thinking,
v. Flexibility,
w. Conflict resolution,
x. Responsibility,
y. Self-control,
z. Positive attitude.
